(19) United States
(12) Patent Application Publication
(10) Pub. No.: US 2009/0262155 A1
(43) Pub. Date: Oct. 22, 2009

(54) COMPLEX SYSTEM HAVING INK-JET PRINTING FUNCTION AND TESTING FUNCTION, AND AN INK-JET PRINTING APPARATUS HAVING THE SAME

(75) Inventor: Min-Ho Kim, Seoul (KR)

Correspondence Address: POLSINELLI SHUGHART PC, 700 W. 47TH STREET, SUITE 1000, KANSAS CITY, MO, 64112-1802, US

(73) Assignee: Naraenanotech Corporation, Yongin-City (KR)

(21) Appl. No.: 12/425,008

(22) Filed: Apr. 16, 2009

(30) Foreign Application Priority Data
Apr. 17, 2008 (KR) 10-2008-0035827

(51) Int. Cl. B41J 29/38

(52) U.S. Cl. 347/9

(57) ABSTRACT

A complex system having an ink-jet printing function and a testing function, and an ink-jet printing apparatus having the same is disclosed. The complex system includes a plurality of ink-jet heads for feeding ink to form a plurality of patterns on a printing object. A gantry is movable over the printing object where the plurality of ink-jet heads is mounted. In addition, the complex system includes at least one test device, being mounted on a back side of the gantry, for testing the status of the plurality of patterns formed on the printing object; and a controller for controlling respective operations of the plurality of ink-jet heads, the gantry, and at least one test device.

### FIELD

This document relates to a complex system and printing apparatus, and more particularly to a complex system and ink-jet printing apparatus having ink-jet printing and testing functions.

### CROSS REFERENCE TO RELATED APPLICATION

The present application claims priority to Korean Patent Application Serial No. 10-2008-0035827 filed Apr. 17, 2008, the entire disclosure of which is incorporated herein by reference.

### BACKGROUND

Generally, it is required to form predetermined patterns such as electrodes or dots on a glass surface or a printed circuit board (PCB) by using, for example, a photo-resist (PR) solution or a metal paste such as copper (Cu), silver (Ag), aluminum (Al), etc., in order to manufacture electronic circuit components, or a flat panel display (FPD), such as a plasma display panel (PDP) or a liquid crystal display (LCD).

As one method for forming the predetermined patterns described above, there has been used, for example, a method of patterning the predetermined patterns directly in a manner of an off-set printing type using two rolls or a method of patterning the predetermined patterns directly by using an ink-jet printing apparatus having ink-jet heads for ejecting ink droplets.

FIG. 1A illustrates a perspective view of an ink-jet printing apparatus according to prior art. As shown, an ink-jet printing apparatus 100 according to prior art may include, for example, a plurality of ink-jet heads 120 for feeding ink to form a plurality of patterns 114 on a printing object 110. A gantry 130 may be movable over the printing object 110 where the plurality of ink-jet heads 120 is mounted, while an ink reserving device 150, may be connected to the plurality of ink-jet heads 120, respectively, for feeding ink. Hereinafter, operations of the ink-jet printing apparatus 100 according to prior art will be described in detail.

As further shown, in the ink-jet printing apparatus 100, ink is fed in advance from the ink reserving device 150 to the plurality of ink-jet heads 120 through an ink feeding main conduit 152 and a plurality of branch conduits 152a, 152b, 152c, 152d and 152e. Start and stop operations of feeding ink are controlled by a plurality of control valves 156a, 156b, 156c, 156d and 156e. A pressing force of the ink reserving device 150 is provided by pressing a fluid (for example, air) being fed from a conduit for pressing ink. In one embodiment, the feeding of the pressing fluid may be controlled by actuating a fluid control valve 154. After that, while the gantry 130, where the plurality of ink-jet heads 120 is mounted, moves over the printing object 110, ink is fed on the printing object 110 and a plurality of desired patterns 114 is formed thereon. The printing object 110 is positioned on a stage 112 for fixing the printing object 110, while the stage 112 is positioned on a printing apparatus frame 160.

In the meanwhile, the printing object 110 where the plurality of patterns 114 is formed may be moved to a subsequent process step by a separate transferring device (not shown), for example, a robot arm. In this subsequent process step, a test device (not shown) performs a test whether the plurality of patterns 114 on the printing object 110 is formed exactly or not. The test device may include, for example, a known optical sensor, a known optical system, a charge-coupled device (CCD) camera, a scan camera, or a vision camera, etc.

FIG. 1B illustrates a view showing a thermal ink-jet head being used for an ink-jet printing apparatus according to prior art illustrated in FIG. 1A and its operations in detail. A thermal ink-jet head 120 according to prior art illustrates any one ink-jet head 120 out of the plurality of ink-jet heads 120 illustrated in FIG. 1A. In the thermal ink-jet head 120, when an electric power pulse is applied to heater 122, ink within a chamber 124 is heated and expanded instantaneously and then is ejected in the shape of a droplet 128 through a nozzle hole 126. Accordingly, in cases where the plurality of ink-jet heads 120, respectively, illustrated in FIG. 1a is the thermal ink-jet head 120 illustrated in FIG. 1B, the ink droplet 128 is ejected through the nozzle hole 126 due to an instantaneous heating by heater 122, and thus the plurality of desired patterns 114 is formed.

FIG. 1C illustrates a view showing a piezo ink-jet head being used for an ink-jet printing apparatus according to prior art illustrated in FIG. 1a and its operations in detail. A piezo ink-jet head 120 according to prior art illustrates any one ink-jet head 120 out of the plurality of ink-jet heads 120 illustrated in FIG. 1A. In the piezo ink-jet head 120, deformation is applied to a piezoelectric element 121 attached to the piezo ink-jet head 120 by a piezoelectric driver 123. The applied deformation oscillates a meniscus 124 within the piezo ink-jet head 120 so that ink is formed as a droplet from a nozzle hole 126 of the piezo ink-jet head 120, and then is ejected.

In the ink-jet printing apparatus 100 as described above in detail, various types of a PR solution or a metal paste (hereinafter, commonly referred to as “ink”) may be typically utilized for the ink being used for the plurality of ink-jet heads 120. In addition, the nozzle hole 126 of the ink-jet head 120 may have a narrow size with a diameter of approximately several to several-tens micrometers (for example, 20D).

In the ink-jet printing apparatus 100 as described above, a printing process of forming the plurality of patterns 114 on the printing object 110 and a testing process on a printing status after completion of the printing process are performed independently as a separate process by respective separate devices. Accordingly, there are problems in the ink-jet printing apparatus 100 as follows:
1. Because the printing process and the testing process on the printing status are performed independently, a transferring process of the printing object 110 wherein the plurality of patterns 114 is formed is required for performing the testing process after the completion of the printing process. Accordingly, a tact time is increased due to the time required for transferring the printing object 110, and costs are increased as well because the separate transferring process and a separate transferring device are required.
2. When ink is required to be fed additionally as a test result of the plurality of patterns 114 formed on the printing object 110 (for example, in cases where ink is insufficiently coated), the printing object 110 needs to be transferred again to a printing process step, which is prior to a testing process step, and then additional ink is required to be fed. In this case, a subsequent printing process that is under processing must be stopped, and additional processes conducted due to an additional transfer and an additional test of the printing object 110 are required. Therefore, when a printing status is poor during the testing process, there are problems not only with the printing process and the testing process being very inefficient, but also the number of processes and the processing time are increased due to an additional transferring and testing processes.
3. Further, when an additional process such as an etching process is required due to, for example, ink being excessively coated on R, G, B patterns as a test result of the plurality of patterns 114 formed on the printing object 110, the printing object 110 may be transferred onto a separate etching device and an etching process thereof may be performed. In this case, in order to solve the errors (an excessive coating of ink, etc.) found during a testing process step, it is required to adjust independently a coating amount of ink of the ink-jet printing apparatus 100 during a printing process to be performed subsequently and this requires a substantial amount of manpower and time. In addition, even if the errors (an excessive coating of ink, etc.) are found during a testing process step, such errors are not fed back in real time to the ink-jet printing apparatus 100 so that the same errors occur continuously during a printing process to be performed subsequently until the errors are solved.

Accordingly, a new method for solving the problems described above is required.

### SUMMARY

In an embodiment, a complex system having an ink-jet printing function and a testing function may include a plurality of ink-jet heads for feeding ink to form a plurality of patterns on a printing object. A gantry may be movable over the printing object where the plurality of ink-jet heads is mounted. In addition, at least one test device may be mounted on a back side of the gantry for testing a status of the plurality of patterns formed on the printing object and a controller may be provided for controlling respective operations of the plurality of ink-jet heads, the gantry, and the at least one test device.

In another embodiment, an ink-jet printing apparatus may include a plurality of ink-jet heads for feeding ink to form a plurality of patterns on a printing object. A gantry may be movable over the printing object where the plurality of ink-jet heads is mounted. In addition, at least one test device may be mounted on a back side of the gantry for testing a status of the plurality of patterns formed on the printing object. An ink reserving device may also be connected to the plurality of ink-jet heads, respectively, for reserving ink to be fed to the plurality of ink-jet heads. Moreover, a controller may be provided for controlling respective operations of the plurality of ink-jet heads, the gantry, and the at least one test device, wherein the plurality of ink-jet heads, the gantry, at least one test device, and the controller form a complex system having an ink-jet printing function and a testing function.

Additional objectives, advantages and novel features will be set forth in the description which follows or will become apparent to those skilled in the art upon examination of the drawings and detailed description which follows

### BRIEF DESCRIPTION OF THE DRAWINGS

FIG. 1A illustrates a perspective view of an ink-jet printing apparatus according to prior art;

FIG. 1B illustrates a view showing a thermal ink-jet head being used for an ink-jet printing apparatus according to prior art illustrated in FIG. 1A and its operations in detail;

FIG. 1C illustrates a view showing a piezo ink-jet head being used for an ink-jet printing apparatus according to prior art illustrated in FIG. 1a and its operations in detail;

FIG. 2A illustrates a perspective view of an ink-jet printing apparatus according to one embodiment;

FIG. 2B illustrates a schematic block diagram of an ink-jet printing apparatus according to one embodiment illustrated in FIG. 2A;

FIG. 2C illustrates a schematic partial side-sectional view of a complex system having a test device being used for an ink-jet printing apparatus according to one embodiment illustrated in FIG. 2A; and

FIG. 2D illustrates a real image and a three-dimensional analysis image of a plurality of patterns that are transmitted from a controller to a display device within a test device as illustrated in FIGS. 2A and 2B.

Corresponding reference characters indicate corresponding elements among the views of the drawings. The headings used in the Figures should not be interpreted to limit the scope of the claims.

### DETAILED DESCRIPTION

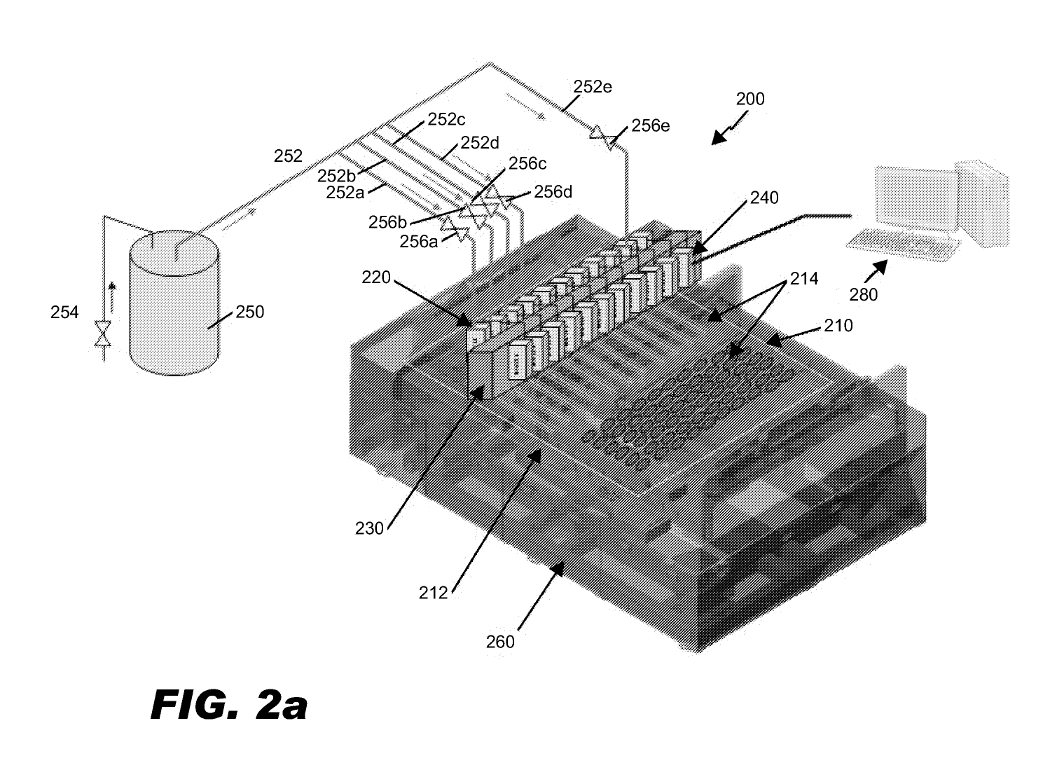

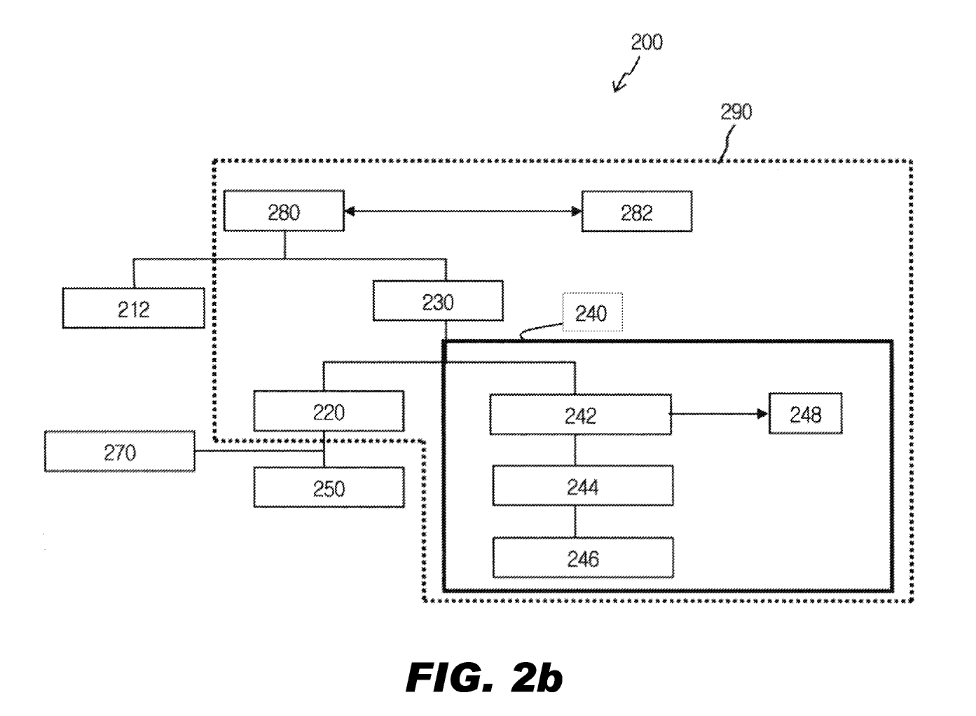

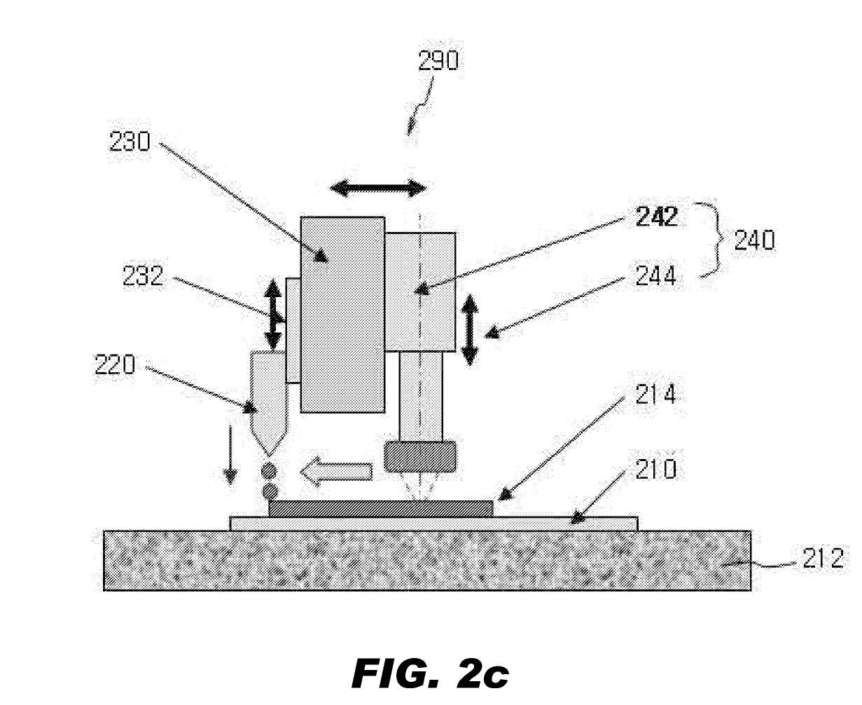

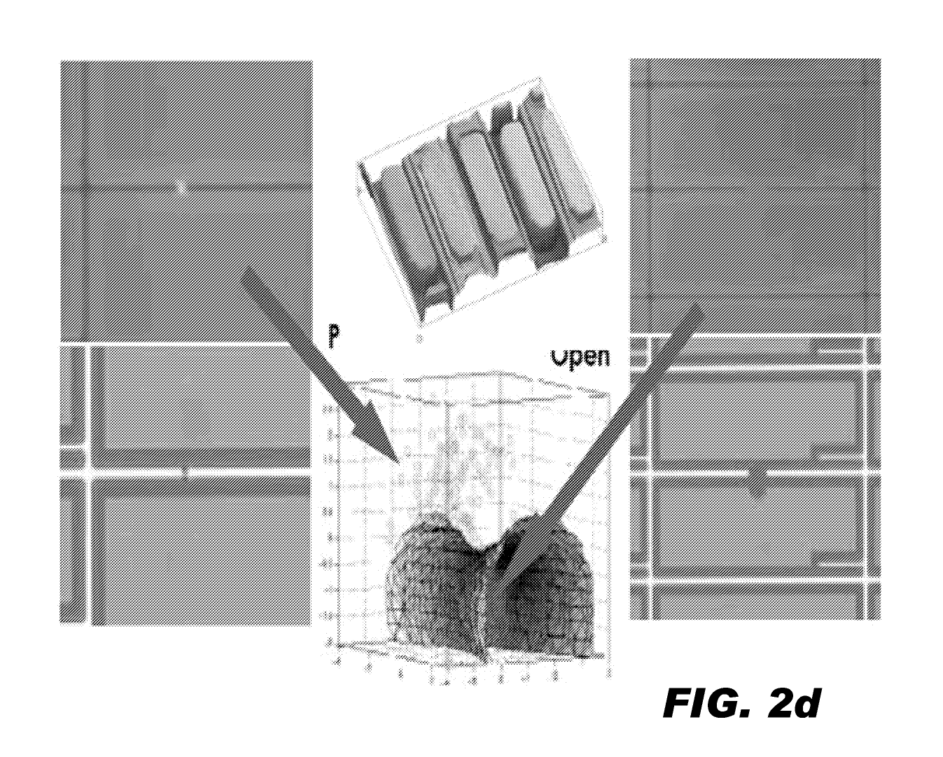

Referring to the drawings, an exemplary embodiment of a complex system is illustrated and generally indicated as 290 in FIGS. 2A-2D that is designed to solve the prior art problems described above and to provide the complex system 290 having an ink-jet printing function and a testing function, and an ink-jet printing apparatus 200 having the same wherein, the number of processes, and costs necessary for testing a printing process and a printing status are reduced and where productivity and efficiency are significantly improved by monitoring and feeding back a test result on the printing status so as to apply the test result to a subsequent printing process and thus to remove problems of the subsequent printing process.

The various embodiments of the complex system 290 may accomplish the following advantages:
1. Because a printing process and a testing process of a printing status are performed simultaneously and in real time, unlike prior art, a transferring process and a transferring device required for performing a testing process are unnecessary, and thus a tact time and costs are reduced.
2. When an additional subsequent process is required as a test result of a plurality of patterns formed on a printing object, such an additional subsequent process may be performed rapidly, easily, and efficiently.
3. It is possible to build a database relating to a test result of a plurality of patterns formed on a printing object.
4. It is possible to remove the problems of a subsequent printing process by monitoring and feeding back a test result of a printing status in order to apply the test result to the subsequent printing process.
5. Productivity and efficiency of an ink-jet printing apparatus are significantly improved.

Hereinafter, the complex system 290 will be described in more detail with reference to preferred embodiments and appended drawings.

FIG. 2A illustrates a perspective view of an ink-jet printing apparatus according to one embodiment. As shown, ink-jet printing apparatus 200 according to one embodiment and includes a plurality of ink-jet heads 220 for feeding ink to form a plurality of patterns 214 on a printing object 210. A gantry 230 may be movable over the printing object 210 where the plurality of ink-jet heads 220 is mounted. In addition, at least one test device 240, being mounted on a back side of the gantry 230, for testing a status of the plurality of patterns 214 formed on the printing object 210 and an ink reserving device 250, being connected to the plurality of ink-jet heads 220, respectively, for reserving ink to be fed to the plurality of ink-jet heads 220. A controller 280 may be provided for controlling respective operations of the plurality of ink-jet heads 220, the gantry 230, at least one test device 240, and the ink reserving device 250. The plurality of ink-jet heads 220, the gantry 230, at least one test device 240, and the controller 280 of the ink-jet printing apparatus 200 form a complex system 290 as will be described later. Further, as can be seen from FIG. 2A, the printing object 210 is positioned on a stage 212 for fixing the printing object 210, while the stage 212 is positioned on a printing apparatus frame 260.

FIG. 2B illustrates a schematic block diagram of an ink-jet printing apparatus according to one embodiment illustrated in FIG. 2A, while FIG. 2C illustrates a schematic partial side-sectional view of a complex system having a test device being used for an ink-jet printing apparatus according to one embodiment illustrated in FIG. 2A. Reference numeral 270 shown in FIG. 2B (not shown in FIG. 2A) indicates a cleaning device. A detailed disclosure of a cleaning device 270 is described in detail in Korean Patent Application No. 10-2008-0016795 filed on Feb. 25, 2008 by the applicant of the present application, entitled “A Cleaning Device of A Head for Ink-Jet Printing Apparatus, and A Head for Ink-Jet Printing Apparatus and An Ink-Jet Printing Apparatus Having the Same.” The disclosure of Korean Patent Application No. 10-2008-0016795 is incorporated by reference herein in its entirety.

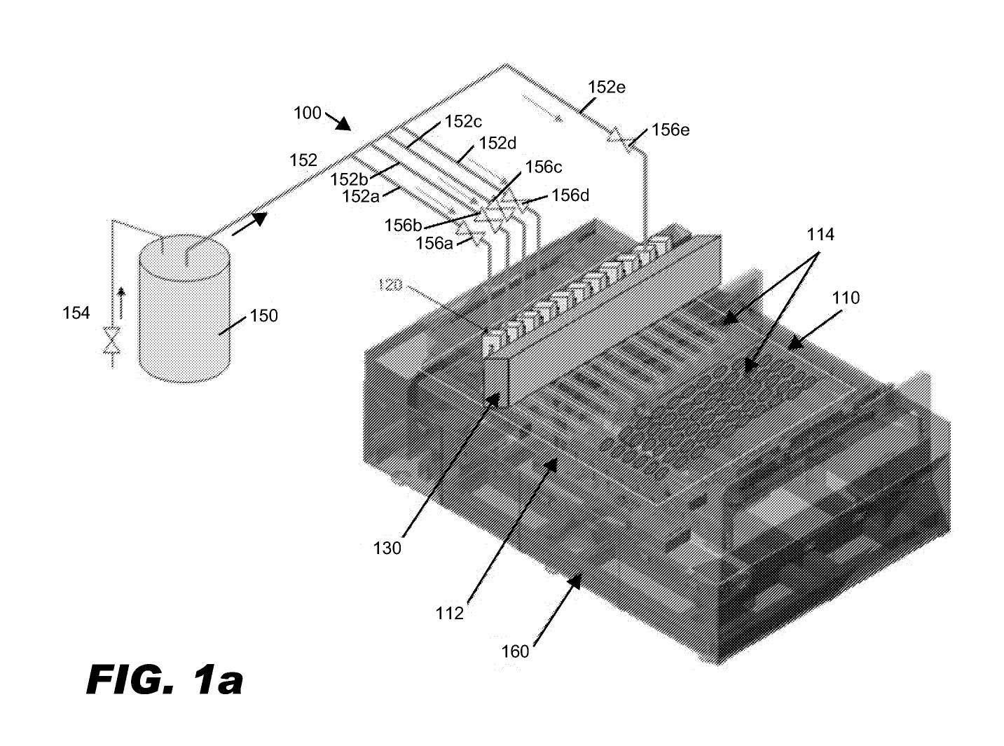

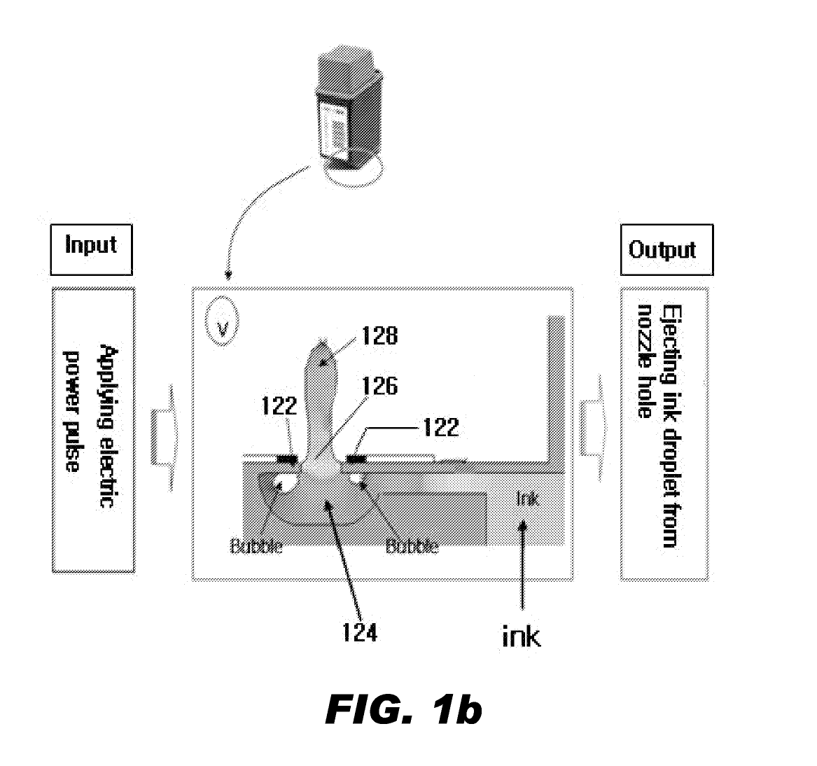

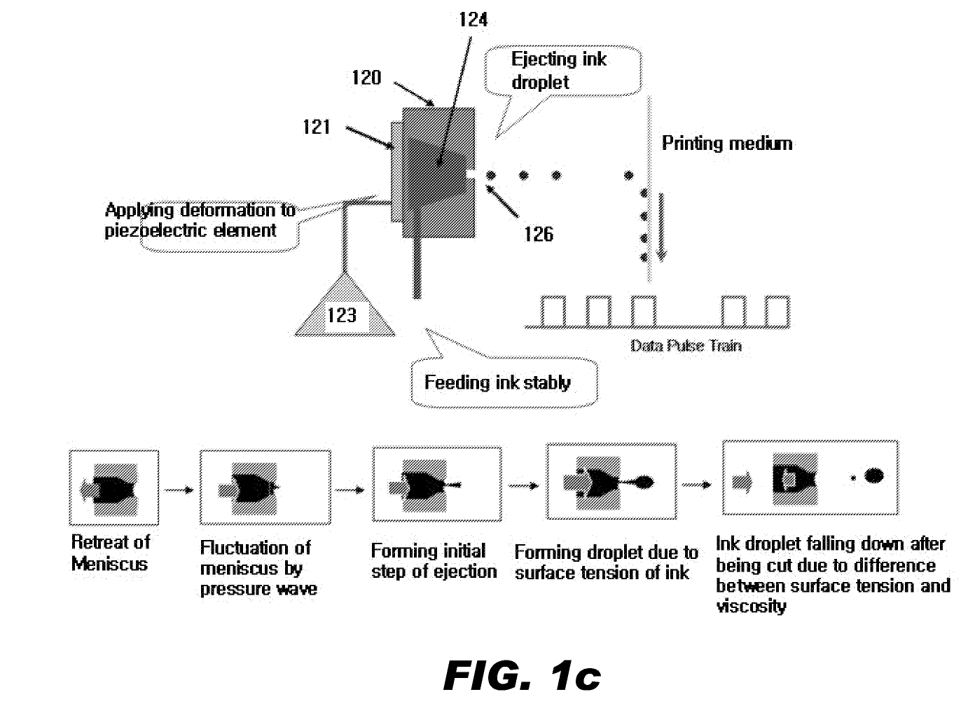

Referring to FIGS. 2A through 2C, a complex system 290 according to one embodiment includes a plurality of ink-jet heads 220 for feeding ink to form a plurality of patterns 214 on a printing object 210. A gantry 230 may be movable over the printing object 210 where the plurality of ink-jet heads 220 is mounted; at least one test device 240, being mounted on a back side of the gantry 230, for testing a status of the plurality of patterns 214 formed on the printing object 210. A controller 280 may be provided for controlling respective operations of the plurality of ink-jet heads 220, the gantry 230, and at least one test device 240. Each of the plurality of ink-jet heads 220 may be embodied by either the thermal ink-jet head illustrated in FIG. 1B or the piezo ink-jet head illustrated in FIG. 1C. Hereinafter, respective components and their operations of the complex system 290 and the ink-jet printing apparatus 200 having the same components according to one embodiment will be described in detail.

Referring back to FIG. 2A, in the ink-jet printing apparatus 200 of one embodiment, ink is fed in advance from the ink reserving device 250 to the plurality of ink-jet heads 220 through an ink feeding main conduit 252 and a plurality of ink feeding branch conduits 252a, 252b, 252c, 252d, . . . , 252e. Start and stop operations of feeding ink are controlled by a plurality of ink feeding control valves 256a, 256b, 256c, 256d, . . . , 256e. The pressing force of the ink reserving device 250 is provided by pressing a fluid (for example, air) being fed from a conduit for pressing ink. The feeding of pressing fluid may be controlled by a pressing or otherwise actuating fluid control valve 254. After that, while the gantry 230 where the plurality of ink-jet heads 220 is mounted moves over the printing object 210, ink is fed on the printing object 210 and a plurality of desired patterns 214 is formed thereon. Upward and downward movements of the gantry 230 and the plurality of ink-jet heads 220 over the printing object 110 are made by an actuator 232 (see FIG. 2C) attached to the gantry 230. The plurality of patterns 214 is tested by at least one test device 240 mounted on a backside of the gantry 230 whether exact patterns are formed or not (hereinafter referred to “pattern forming status”). Accordingly, in the complex system 290 having at least one test device 240, a printing operation where the plurality of patterns 214 is formed on the printing object 210 by the plurality of ink-jet heads 220 and a testing operation of testing a pattern forming status formed according to the printing operation are performed simultaneously and in real time.

Referring to FIGS. 2B and 2C, the at least one test device 240 being used for the complex system 290 includes an optical device 242 for testing; an auto-focusing device 244 for automatically adjusting a focus of the optical device 242 for testing; and a light source 246 for providing light to be used for the optical device 242 for testing. The optical device 242 for testing may be embodied, for example, by one of any known optical sensor, optical system, CCD camera, scan camera, vision camera, or any combination of these units (for example, one unit where a CCD camera and a scan camera are combined together). Further, a magnification of the optical device 242 for testing may be variably adjustable, for example, by using a plurality of compatible objective lenses, each having a different focus. In addition, the test device 240 may further include a display device 248 capable of displaying information on the pattern forming status of the plurality of patterns 214, such as either one or both of real images, and real widths and heights of the plurality of patterns 214.

In the meanwhile, data including widths and heights, etc. of the plurality of patterns 214 measured by the optical device 242 for testing of the test device 240 is transmitted to the controller 280. The controller 280 may store one or more data out of images, heights, and widths of the plurality of patterns 214. Further, the controller 280 may include software (S/W) capable of analyzing stored data of the plurality of patterns 214. As a result, the controller 280 may analyze the stored data of the plurality of patterns 214 by using the software and measure real widths and heights of the plurality of patterns 214. Further, the controller 280 may transmit real images and/or measured real widths and heights of the plurality of patterns 214 to the display device 248 within the test device 240. An in-situ user may identify the pattern forming status of the plurality of patterns 214 in real time, through the real images and/or the measured real widths and heights of the plurality of patterns 214, which are displayed on the display device 248. Moreover, an appropriate subsequent operation (for example, an etching process due to an excessive coating, or an adjusting process of widths and/or heights of patterns) may be performed without delay, based on the pattern forming status identified in real time.

Further, the controller 280 is connected to an external data input/output device 282 in a wired or wireless manner and is capable of a bi-directional communications. The external data input/output device 282 may be embodied, for example, by a touch screen and may be used for inputting or outputting information necessary for operating respective components of the ink-jet printing apparatus 200 having the complex system 290 into or from the controller 280. In addition, when the data relating to the information on the pattern forming status of the plurality of patterns 214, such as either one or both of real images, and real widths and heights of the plurality of patterns 214, is required to be modified, it is possible that inputting or outputting of modified information of data may be made directly at the controller 280, or may be made by using the external data input/output device 282.

FIG. 2D illustrates a real image and a three-dimensional analysis image of a plurality of patterns that are transmitted from a controller to a display device within a test device as illustrated in FIGS. 2A and 2B. More specifically, a real image of ink patterns formed in each pit of a cell (or a sub-pixel) forming R, G, and B, respectively, and a three-dimensional analysis image showing a width and a height of one pixel comprised of R, G, and B are illustratively displayed. Based on such a pattern forming status identified by using a real image and a three-dimensional analysis image, an appropriate subsequent operation as described above may be performed. The images shown in FIG. 2D are illustrative and any person of ordinary skill in the art may fully understand that other data information (for example, a cell number, etc.) relating to the pattern forming status, aside from the images described above, may be displayed.

In the complex system 290 described above, all the operations of the ink-jet printing apparatus 200 including an ink feeding operation may be controlled, for example, by one controller 280 such as a microprocessor or a personal computer (PC), etc. In addition, any person of ordinary skill in the art may fully understand that an actuator (not shown) having a forced liquid feeding function, such as a pump for controlling pressure that dispenses a feeding amount necessary for feeding ink, may be required in order to feed ink.

The complex system 290 having an ink-jet printing function and a testing function, and the ink-jet printing apparatus 200 having the same is illustratively described to be used for heads for an ink-jet printing apparatus 200 and an ink-jet printing apparatus 200 for forming a plurality of patterns which is required for manufacturing electronic circuit components, or an FPD such as a PDP or an LCD. However, any person of ordinary skill in the art may fully understand that the complex system 290 may be applicable to heads for an ink-jet printing apparatus 200 and an ink-jet printing apparatus 200 for forming a plurality of patterns which may be used for other technical fields, aside from the heads for an ink-jet printing apparatus 200 and the ink-jet printing apparatus 200 for manufacturing an FPD.

As various modifications could be made in the constructions and method herein described and illustrated without departing from the scope of the complex system 290, it is intended that all matter contained in the foregoing description or shown in the accompanying drawings shall be interpreted as illustrative rather than limiting. Thus, the breadth and scope of the complex system 290 should not be limited by any of the above-described exemplary embodiments, but should be defined only in accordance with the following claims appended hereto and their equivalents.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A complex system having an ink-jet printing function and a testing function comprising:
a plurality of ink-jet heads for feeding ink to form a plurality of patterns on a printing object;
a gantry movable over the printing object where the plurality of ink-jet heads is mounted;
at least one test device, being mounted on a back side of the gantry, for testing a status of the plurality of patterns formed on the printing object; and
a controller for controlling respective operations of the plurality of ink-jet heads, the gantry, and the at least one test device.

2. The complex system of claim 1, wherein the at least one test device comprises:
an optical device for testing;
an auto-focusing device for automatically adjusting a focus of the optical device for testing; and
a light source for providing light to be used for the optical device for testing.

3. The complex system of claim 2, wherein the optical device for testing is embodied in anyone of an optical sensor, an optical system, a CCD camera, a scan camera, a vision camera, and in any combination thereof.

4. The complex system of claim 2, wherein a magnification of the optical device for testing is variably adjustable by using a plurality of compatible objective lenses, each having a different focus.

5. The complex system of claim 2, wherein the test device further includes a display device capable of displaying information on a pattern forming status of the plurality of patterns.

6. The complex system of claim 5, wherein the information on the pattern forming status includes either one or both of real images, and real widths and heights of the plurality of patterns.

7. The complex system of claims 1, wherein the complex system further includes an external data input/output device, being connected to the controller in a wired or wireless manner so as to be capable of a bi-directional communications, for inputting and outputting information necessary for operating the complex system or modified information of data relating to the pattern forming status of the plurality of patterns.

8. The complex system of claim 1, wherein the plurality of ink-jet heads is each embodied by either a thermal ink-jet head or a piezo ink-jet head.

9. The complex system of claim 7, wherein the plurality of ink-jet heads is each embodied by either a thermal ink-jet head or a piezo ink-jet head.

10. The complex system of claim 1, wherein the ink is a photo-resist solution or a metal paste.

11. The complex system of claim 7, wherein the ink is a photo-resist solution or a metal paste.

12. An ink-jet printing apparatus comprising:
a plurality of ink-jet heads for feeding ink to form a plurality of patterns on a printing object;
a gantry movable over the printing object where the plurality of ink-jet heads is mounted;
at least one test device, being mounted on a back side of the gantry, for testing a status of the plurality of patterns formed on the printing object;
an ink reserving device, being connected to the plurality of ink-jet heads, respectively, for reserving ink to be fed to the plurality of ink-jet heads; and
a controller for controlling respective operations of the plurality of ink-jet heads, the gantry, and the at least one test device,
wherein the plurality of ink-jet heads, the gantry, the at least one test device, and the controller form a complex system having an ink-jet printing function and a testing function.

13. The ink-jet printing apparatus of claim 12, wherein the at least one test device comprises:
an optical device for testing;
an auto-focusing device for automatically adjusting a focus of the optical device for testing; and
a light source for providing light to be used for the optical device for testing.

14. The ink-jet printing apparatus of claim 13, wherein the optical device for testing is embodied anyone of a known optical sensor, a known optical system, a CCD camera, a scan camera, a vision camera, and any combination unit thereof.

15. The ink-jet printing apparatus of claim 13, wherein a magnification of the optical device for testing is variably adjustable by using a plurality of compatible objective lenses, each having a different focus.

16. The ink-jet printing apparatus of claim 13, wherein the test device further includes a display device capable of displaying information on a pattern forming status of the plurality of patterns.

17. The ink-jet printing apparatus of claim 16, wherein the information on the pattern forming status includes either one or both of real images, and real widths and heights of the plurality of patterns.

18. The ink-jet printing apparatus of claim 12, wherein the complex system further includes an external data input/output device, being connected to the controller in a wired or wireless manner so as to be capable of a bi-directional communications, for inputting and outputting information necessary for operating the complex system or modified information of data relating to the pattern forming status of the plurality of patterns.

19. The ink-jet printing apparatus of claim 12, wherein the plurality of ink-jet heads is each embodied by either a thermal ink-jet head or a piezo ink-jet head.

20. The ink-jet printing apparatus of claim 18, wherein the plurality of ink-jet heads is each embodied by either a thermal ink-jet head or a piezo ink-jet head.

21. The ink-jet printing apparatus of claim 12, wherein the ink is a photo-resist solution or a metal paste.

22. The ink-jet printing apparatus of claim 18, wherein the ink is a photo-resist solution or a metal paste.
